(19) United States
(12) Patent Application Publication
(10) Pub. No.: US 2025/0388079 A1
(43) Pub. Date: Dec. 25, 2025

(54) Gearbox X force Power plant

(71) Applicant: JOMODE ELIE GETTY, Jersey City, NJ (US)

(72) Inventor: JOMODE ELIE GETTY, Jersey City, NJ (US)

(21) Appl. No.: 19/007,475

(22) Filed: Dec. 31, 2024

(51) Int. Cl. B60K 17/12; B60K 17/16; B60K 17/22

(52) U.S. Cl. CPC B60K 17/12; B60K 17/16; B60K 17/22

(57) ABSTRACT

The present invention relates to a power plant system comprising a rechargeable battery based on a jomode battery concept, configured to power an electric motor similar to an electric vehicle motor. The motor is connected via multiple drive shafts to two car gearboxes and, through additional shafts, to four smaller gearboxes. These gearboxes further connect to shaft devices that drive turbines, enabling efficient energy transmission and output. The system is designed to maximize energy multiplication through mechanical transmission processes. Operation of the entire system is regulated by a control device configured to manage speed and temperature to optimize performance.

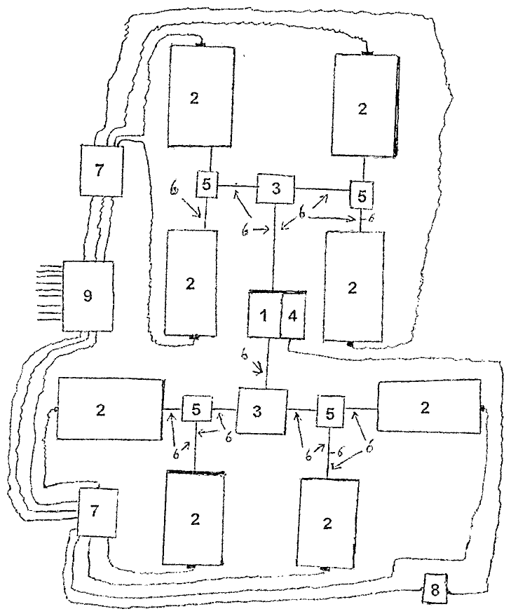

### BACKGROUND OF THE INVENTION

The present invention relates generally to power plant systems and, more specifically, to an improved configuration involving electric motors, drive shafts, gearboxes, and turbine systems optimized for efficient energy transfer and management.

Advances in electric motor technology, energy storage systems, and mechanical transmission devices have enabled new approaches to high-efficiency power generation. Existing systems, however, often face limitations in energy transmission efficiency, control precision, and scalability for advanced applications, such as miniaturized nuclear systems or autonomous robotic energy supplies.

The inventor has extensive experience in the fields of electricity, mechanical engineering, aeronautics, nuclear studies, and physics, which have contributed to the development of this innovative energy system. Building upon years of research into quantum mechanics, force transmission, energy multiplication, and mechanical systems, the present invention seeks to offer a novel integrated solution for high-efficiency power generation and management using electric motors, advanced gearboxes, and control devices.

### DESCRIPTION OF THE DRAWING NUMBER 1

The drawing illustrates the Gearbox X Force Power Plant, a modular and scalable energy system equipped with eight turbines. It is designed to generate electricity for a city of approximately 140,000 households, and also supply power to boats, container ships, tankers, and miniature versions adapted for trains, airplanes, and drones. The system comprises the following components:
1 Electric Motors (1)—Similar to those used in electric vehicles; serve as mechanical drivers for the system.
8 Turbines (2)—Fitted with integrated control devices for speed and temperature regulation, ensuring efficient energy conversion.
2 Gearbox (3)—Connects three shafts and includes mechanisms for managing speed and temperature, enabling smooth power transmission.
1 Battery (Jomode Concept) (4)—A rapidly rechargeable, high-efficiency rechargeable battery for energy storage and buffering.
4 Three-Shaft Gearbox (5)—Coordinates power flow between turbines, motors, and the battery system.
8 Shafts (6)—Mechanical components transmitting torque throughout the system.
2 Step-Down Transformers (7)—Two output paths from the system lead into these transformers, which reduce voltage to levels suitable for consumer use.
1 Speed Charger (8)—Supports fast charging of the battery for high-demand performance to (4).
1 Electricity Distribution Network (9)—Receives power from the step-down transformers (7) and distributes it to homes, industries, and infrastructure.

Zigzag Electrical Cable Connection connect the turbines to the step-down transformers, to battery enhancing transmission flexibility.

What is claimed is:

1. A power plant comprising:
(a) an electric motor similar to an electric vehicle motor;
(b) two car gearboxes, each connected to three shafts;
(c) fourteen drive shafts;
(d) four small gearboxes, each connected to three shafts;
(e) a speed charger; and
(f) two step-down transformers.

2. The power plant of claim 1, further comprising a rechargeable battery based on a jomode battery concept, wherein the battery powers the electric motor, the motor drives the drive shafts, the drive shafts turn the gearboxes, and the gearboxes connect to shaft devices that drive eight turbines.

3. The power plant of claim 2, further comprising a control device configured to regulate speed and temperature during operation.
